(19) United States
(12) Patent Application Publication
(10) Pub. No.: US 2015/0009327 A1
(43) Pub. Date: Jan. 8, 2015

(54) IMAGE CAPTURE DEVICE FOR MOVING VEHICLES

(71) Applicant: Verizon Patent and Licensing Inc., Basking Ridge, NJ (US)

(72) Inventor: David D. LOVE, Irving, TX (US)

(21) Appl. No.: 13/933,677

(22) Filed: Jul. 2, 2013

(51) Int. Cl. H04N 7/18

(52) U.S. Cl. CPC H04N 7/181
USPC 348/148

(57) ABSTRACT

A device is configured to determine location information associated with a set of image capture devices, and determine an object location associated with an object. The device is configured to select an image capture device, of the set of image capture devices, based on the location information and the object location. The image capture device may be selected based on the location information, of the image capture device, relative to the location information of other ones of the set of image capture devices. The device is configured to receive image information associated with the image capture device based on selecting the image capture device, where the image information includes an image of the object. The device is configured to provide the image information.

### BACKGROUND

An image capture device, such as a digital camera, a video camera, a smartphone, or a computer device, may be used to capture images (e.g., pictures, videos, etc.) of surrounding objects. The image capture device may provide the images via a network to another device, such as a computer device, a server device, or the like.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3A is a diagram of example components of one or more devices of FIG. 2;

FIG. 3B is a diagram of an example configuration of a device of FIG. 2;

FIG. 3C is a diagram of another example configuration of a device of FIG. 2;

FIG. 4 is a flow chart of an example process for receiving image information associated with an image capture device;

FIGS. 5A-5C are diagrams of an example implementation relating to the example process shown in FIG. 4;

FIGS. 6A-6B are diagrams of another example implementation relating to the example process shown in FIG. 4;

FIG. 7 is a diagram of yet another example implementation relating to the example process shown in FIG. 4; and

FIGS. 8A-8C are diagrams of yet another example implementation relating to the example process shown in FIG. 4.

### DETAILED DESCRIPTION OF PREFERRED EMBODIMENTS

The following detailed description of example implementations refers to the accompanying drawings. The same reference numbers in different drawings may identify the same or similar elements.

An image capture device (e.g., a camera, a video recorder, a smartphone, etc.) may capture images (e.g., pictures, videos, etc.) of one or more surrounding objects. An image capture device may be associated with a vehicle (e.g., a car, a bus, a train, etc.), and may travel around a region (e.g., a town, a city, a state, etc.). A control device may monitor movements of a set of image capture devices by determining locations associated with the set of image capture devices.

The control device may determine an object location associated with an object, such as a street, a building, a park, or the like. The object may be of interest to a user of the control device, such as a scene of an emergency. Based on the object location, the control device may determine an image capture device, of the set of image capture devices, which is closest to the object or positioned to capture an image of the object. The control device may receive an image of the object from the image capture device. Implementations described herein may allow a control device to determine an image capture device near an object, and to receive a real-time image of the object.

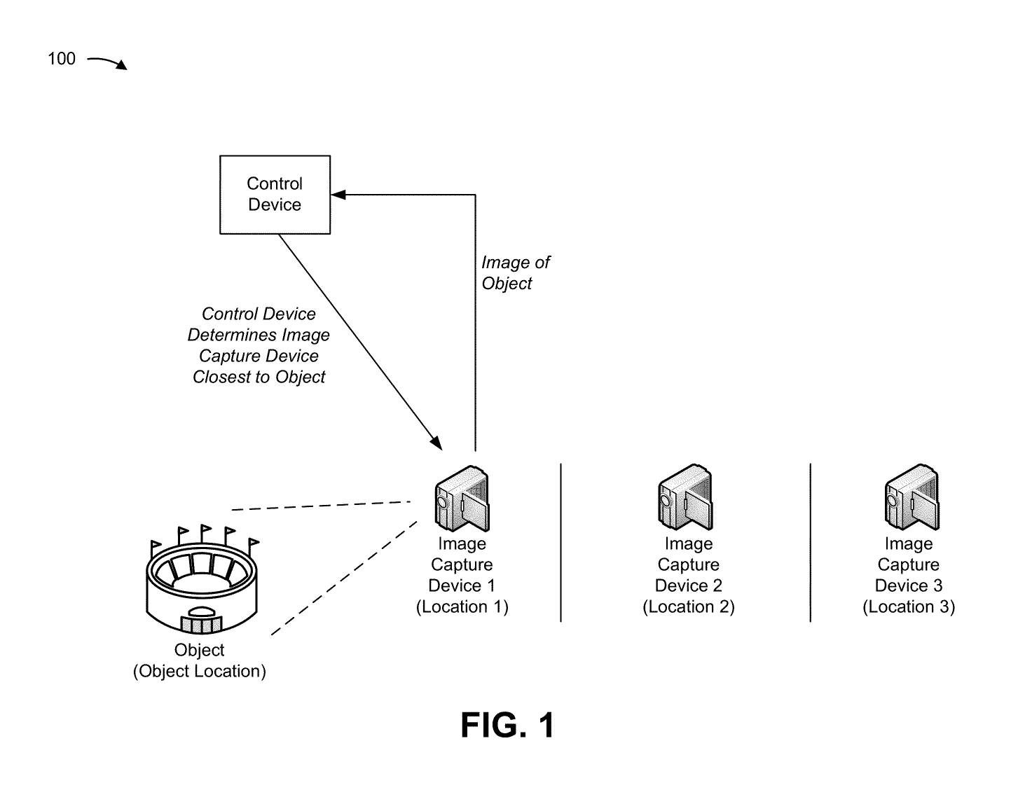

FIG. 1 is a diagram of an overview of an example implementation 100 described herein. As shown in FIG. 1, example implementation 100 may include a set of image capture devices, a control device, and an object.

As shown in FIG. 1, the set of image capture devices may include a first image capture device (e.g., a first camera) located at a first location, a second image capture device (e.g., a second camera) located at a second location, and a third image capture device (e.g., a third camera) located at a third location. The set of image capture devices may be connected via a network to the control device. The control device may determine locations associated with the set of image capture devices by receiving location information (e.g., the first location, the second location, and the third location).

As further shown in FIG. 1, the control device may receive an object location associated with an object (e.g., a stadium). Based on the object location and the locations of the set of image capture devices, the control device may determine an image capture device (e.g., the first camera), of the set of image capture devices, that is closest to the object (e.g., that is within a viewing distance of the stadium). The control device may receive an image of the object from the image capture device. Additionally, or alternatively, the control device may receive a set of images from the set of image capture devices, and may select the image capture device associated with a best image of the object (e.g., an image associated with a clear view of the object). In this manner, the control device may determine an image capture device near to an object and may receive a real-time image of the object.

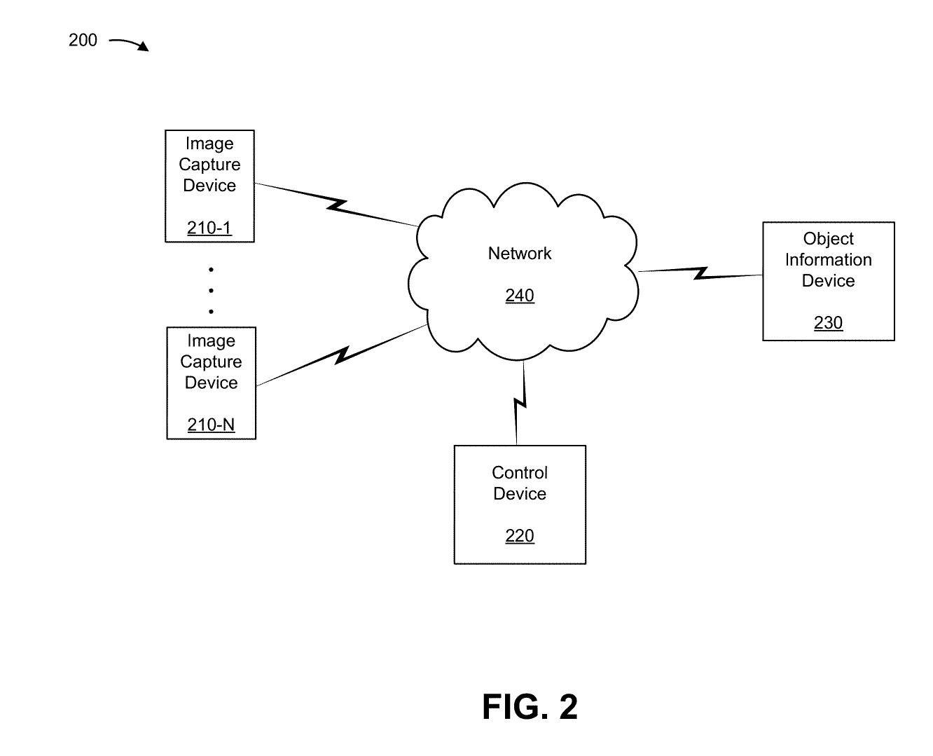

FIG. 2 is a diagram of an example environment 200 in which systems and/or methods described herein may be implemented. As shown in FIG. 2, environment 200 may include image capture devices 210-1 . . . 210-N (N≧1) (hereinafter referred to collectively as “image capture devices 210,” and individually as “image capture device 210”), control device 220, object information device 230, and network 240. Devices of environment 200 may interconnect via wired connections, wireless connections, or a combination of wired and wireless connections.

Image capture device 210 may include a device capable of receiving and/or transmitting one or more images of a surrounding area. In some implementations, image capture device 210 may include a camera (e.g., a digital camera), a video recorder (e.g., a camcorder, a video camera, etc.), a computing device (e.g., a laptop computer, a handheld computer, a tablet computer, etc.), a mobile phone (e.g., a smartphone, a radio telephone, etc.), a gaming device, or a similar device. In some implementations, image capture device 210 may include one or more optics (e.g., mirrors, lenses, etc.) that provide a view in multiple directions (e.g., a 90° view, a 180° view, a 360° view, etc.). Image capture device 210 may receive information from and/or transmit information to control device 220 and/or object information device 230 (e.g., information associated with an image, information associated with a video, information associated with a location, etc.).

Control device 220 may include a device capable of determining a location associated with image capture device 210 and/or receiving image information from image capture device 210 (e.g., information associated with an image, a video, etc.). For example, control device 220 may include a computing device, (e.g., a laptop computer, a handheld computer, a tablet computer, a server, etc.), a mobile phone (e.g., a smartphone), or a similar device. Control device 220 may receive information from and/or transmit information to image capture device 210 and/or object information device 230 (e.g., information associated with an image, information associated with a video, information associated with a location, etc.).

Object information device 230 may include a device capable of receiving, processing, storing, and/or providing information, such as information associated with an object. For example, object information device 230 may include one or more computation or communication devices, such as a server device. Object information device 230 may receive information from and/or transmit information to image capture device 210 and/or control device 220 (e.g., information associated with an object).

Network 240 may include one or more wired and/or wireless networks. For example, network 240 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

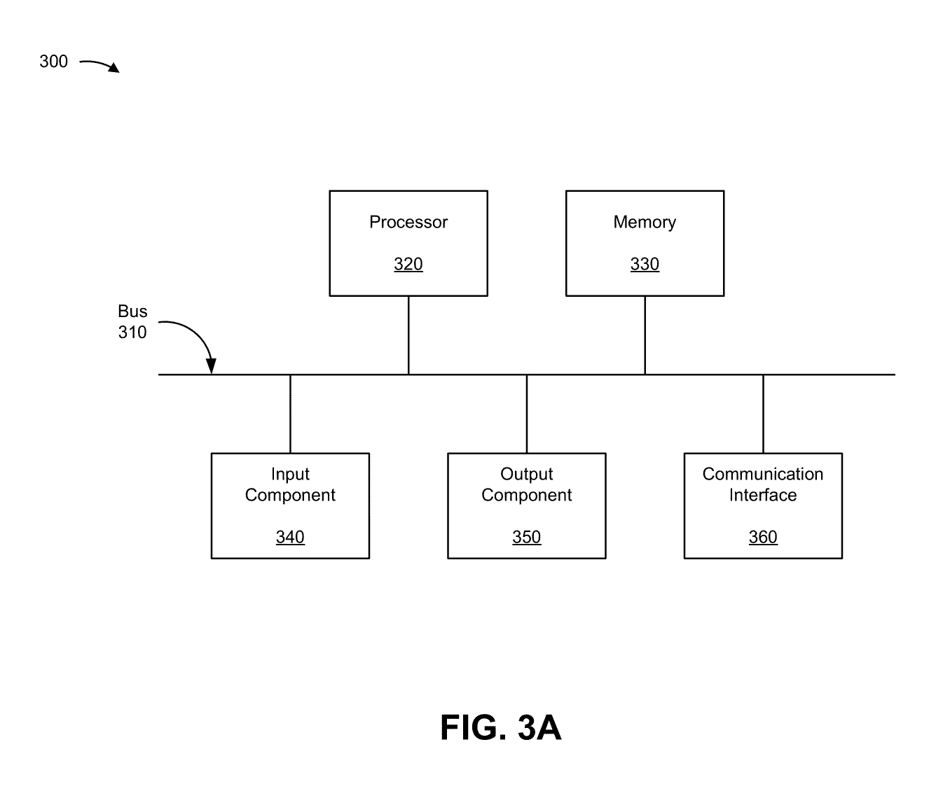

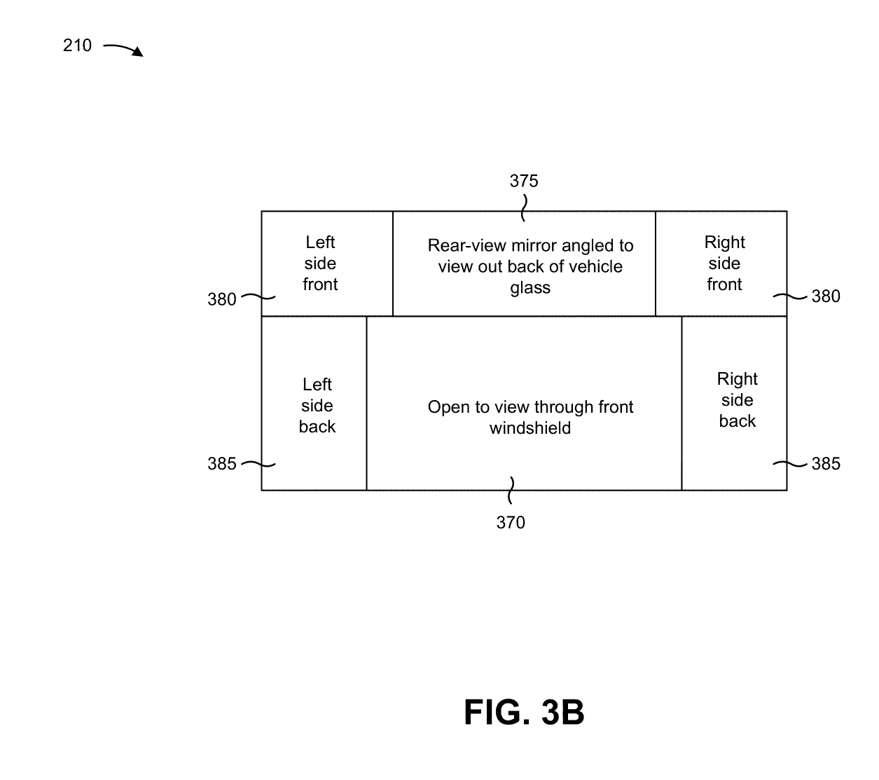

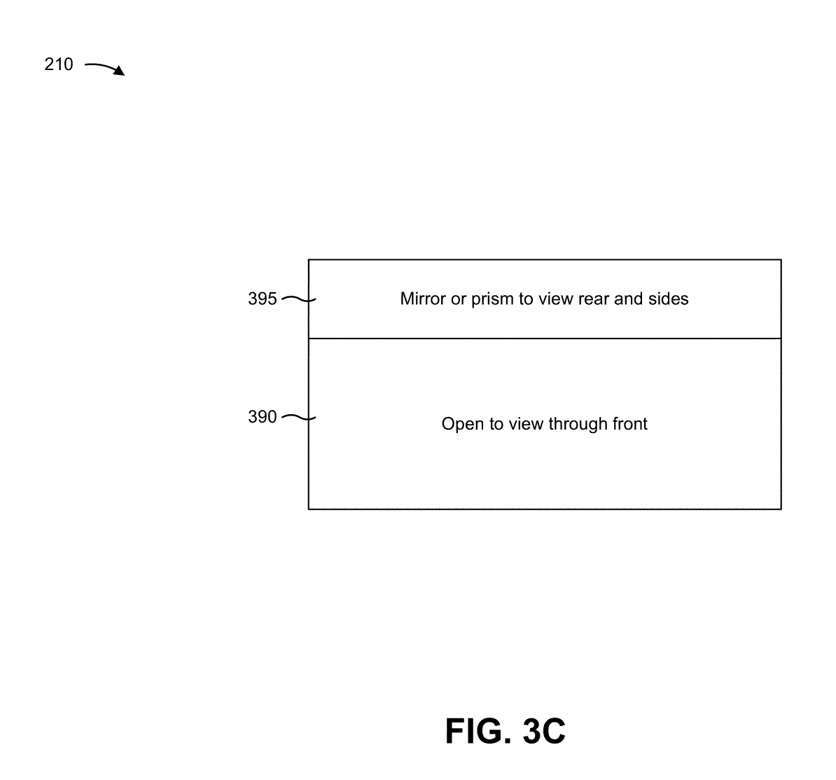

FIG. 3A is a diagram of example components of a device 300. Device 300 may correspond to image capture device 210, control device 220, and/or object information device 230. Additionally, or alternatively, each of image capture device 210, control device 220, and/or object information device 230 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing component (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g. a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3A is provided for explanatory purposes. In practice, device 300 may include additional components, fewer components, different components, or differently arranged components than those shown in FIG. 3A.

FIG. 3B is a diagram of an example configuration of image capture device 210. Image capture device 210 may include a camera capable of capturing an image (e.g., a picture, a video, etc.) of multiple regions surrounding a vehicle by viewing regions surrounding the vehicle in front of the camera and/or by the use of mirrors.

As shown by reference number 370, a region of the image may capture a view from the front of the vehicle. For example, image capture device 210 may be configured to capture images of objects as seen through a front windshield. As shown by reference number 375, a region of the image may capture a view from the rear of the vehicle. For example, image capture device 210 may be configured to view a rear view mirror associated with the vehicle (e.g., a rear-view mirror angled so that image capture device 210 may capture an image through the rear of the vehicle).

As shown by reference number 380, a region of the image may capture a view from a front-left side of the vehicle, and a region of the image may capture a view from a front-right side of the vehicle. For example, image capture device 210 may be configured to capture one or more mirrors angled to provide the front-left and front-right views. In a similar manner, image capture device 210 may be configured to capture one or more mirrors angled to provide a back-left view and a back-right view, as shown by reference number 385.

In this manner, image capture device 210 may capture images of multiple views surrounding the vehicle. Such a configuration may reduce motion sickness from viewing the images, as the configuration may allow a user of image capture device 210 to view an image with regions configured in a manner consistent with views seen while driving a vehicle.

The configuration shown in FIG. 3B is an example configuration of image capture device 210. In practice, image capture device 210 may include a different configuration.

FIG. 3C is a diagram of another example configuration of image capture device 210. Image capture device 210 may include a camera capable of capturing an image (e.g., a picture, a video, etc.) of multiple regions surrounding a vehicle by viewing regions surrounding the vehicle in front of the camera and/or by the use of mirrors and/or prisms.

As shown by reference number 390, a region of the image may capture a view from the front of image capture device 210. For example, image capture device 210 may be placed inside of a vehicle, and may be configured to capture a view of a front windshield associated with the vehicle (e.g., may capture images of objects as seen through the front windshield). Additionally, or alternatively, image capture device 210 may be associated with another region of the vehicle (e.g., on top of the vehicle, below the vehicle, etc.), and image capture device 210 may capture images of objects in front of image capture device 210.

As shown by reference number 395, a region of the image may capture a view from behind image capture device 210. For example, a top portion of a field of view associated with image capture device 210 may include a mirror and/or a prism. The mirror and/or prism may allow image capture device 210 to view objects behind image capture device 210 (e.g., objects as seen from behind image capture device 210). In some implementations, image capture device 210 may be placed inside of a vehicle. In this instance, the mirror may include a rear-view mirror of a car, and image capture device 210 may capture an image as seen through the rear-view mirror of the car. Additionally, or alternatively, the mirror and/or prism may be associated with image capture device 210 (e.g., may be housed inside of image capture device 210).

In some implementations, the mirror and/or prism may capture a view from one or more sides of image capture device 210. For example, image capture device 210 may be placed within a close proximity of the mirror and/or prism, and the mirror and/or prism may provide a view of a substantial portion of the sides (e.g., a view as seen through a rear-seat passenger side window). Additionally, or alternatively, the mirror and/or prism may be rounded to allow for a wider angle of view (e.g., a view wider than a view from a flat mirror and/or prism).

The configuration shown in FIG. 3C is an example configuration of image capture device 210. In practice, image capture device 210 may include a different configuration.

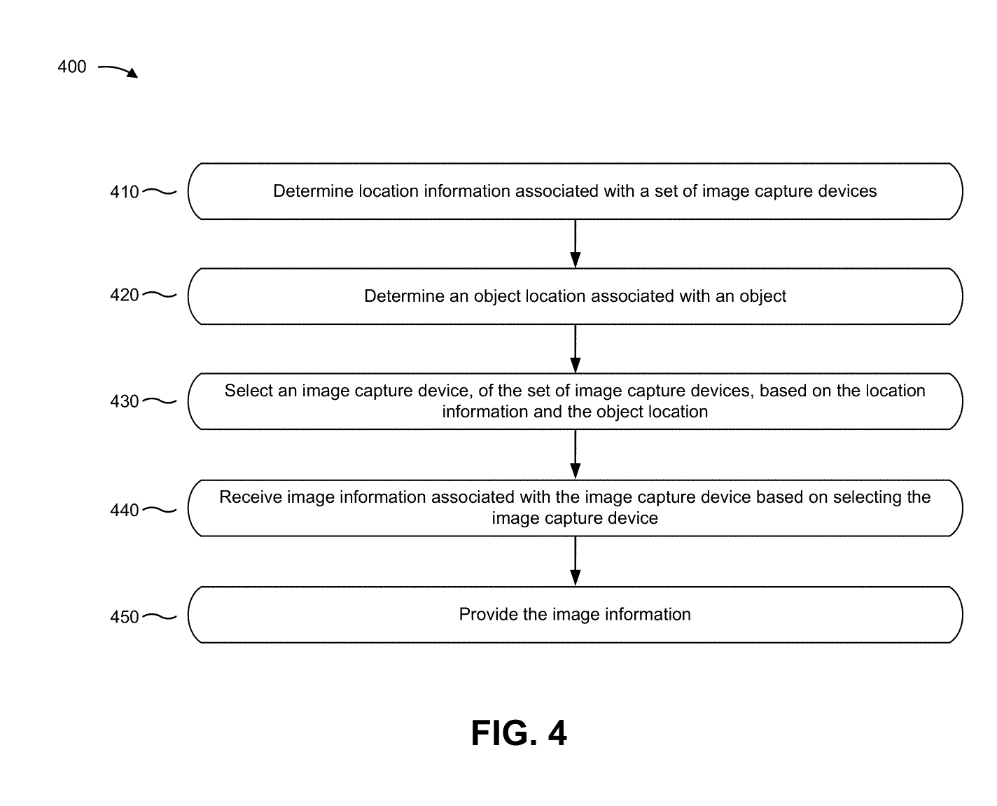

FIG. 4 is a flow chart of an example process 400 for receiving image information associated with an image capture device. In some implementations, one or more process blocks of FIG. 4 may be performed by control device 220. Additionally, or alternatively, one or more process blocks of FIG. 4 may be performed by another device or a group of devices separate from or including control device 220, such as image capture device 210 and/or object information device 230.

As shown in FIG. 4, process 400 may include determining location information associated with a set of image capture devices (block 410). For example, control device 220 may receive location information from image capture device 210.

In some implementations, the location information may include information identifying a geographic location associated with image capture device 210. For example, control device 220 may determine the location of image capture device 210 by use of a global positioning system (“GPS”). For example, image capture device 210 may detect an image capture device location by use of location information determined from the GPS system. Control device 220 may receive a notification from image capture device 210 that identifies the image capture device location (e.g., the location determined via GPS).

In some implementations, image capture device 210 may be associated with or correspond to a cellular device (e.g., a cellular telephone, a smartphone, etc.), and control device 220 may determine the location of image capture device 210 by use of a cellular tower. For example, image capture device 210 may be connected to a cellular telephone network via the cellular tower (e.g., a base station, a base transceiver station (“BTS”), a mobile phone mast, etc.). Control device 220 may determine the location of image capture device 210 by determining the location of the particular cellular tower to which image capture device 210 is connected. Additionally, or alternatively, control device 220 may use two or more cellular towers to determine the location of image capture device 210 by trilateration (e.g., by determining the position of image capture device 210 based on measuring the distance from the cellular tower to image capture device 210), triangulation (e.g., by determining the position of image capture device 210 based on angles from image capture device 210 to a known baseline), multilateration (e.g., by determining the position of image capture device 210 based on the measurement of the difference in distance between two or more cellular towers at known locations broadcasting signals at known times), or the like.

In some implementations, control device 220 may determine the location of image capture device 210 by use of a device that emits an identifying signal, such as a transponder, a radio-frequency identification (“RFID”) tag, a GPS-based object tag (e.g., a micro GPS device), or the like. For example, image capture device 210 may be associated with an RFID tag, and control device 220 may determine the location of image capture device 210 by detecting the RFID tag (e.g., by determining that the RFID tag has been detected by an RFID reader at a particular location).

In some implementations, control device 220 may determine the location of image capture device 210 by receiving user input from image capture device 210. For example, a user of image capture device 210 may provide the location of image capture device 210 by entering location information (e.g., an address, a longitude and a latitude, a GPS position, etc.) into image capture device 210 (e.g., via a user interface associated with image capture device 210). Control device 220 may receive the user input from image capture device 210, and may determine the location of image capture device 210 based on the user input.

In some implementations, image capture device 210 may be associated with a vehicle (e.g., a car, a bus, a truck, etc.). The location information may include the location of the vehicle at a given time. In some implementations, the location information may include a travel history of locations associated with image capture device 210 (e.g., a driving history, a driving log, etc.). For example, image capture device 210 may be associated with a traveling vehicle. As the vehicle travels, image capture device 210 may store (e.g., in a data structure associated with image capture device 210) information that identifies a set of locations and times associated with a movement of image capture device 210.

In some implementations, control device 220 may receive the location information from image capture device 210, and may record the location information as image capture device 210 travels (e.g., may record the history of prior locations in a data structure associated with control device 220). Additionally, or alternatively, a vehicle associated with image capture device 210 may determine the location information via a navigation system associated with the vehicle. Control device 220 may receive the location information from image capture device 210 and/or the vehicle.

As further shown in FIG. 4, process 400 may include determining an object location associated with an object (block 420). The object location may identify a geographic location of the object. In some implementations, control device 220 may receive information that identifies the object location from object information device 230. Additionally, or alternatively, control device 220 may determine the object location from image capture device 210.

In some implementations, the object may include any entity that is visible. For example, the object may include a vehicle (e.g., a car, a truck, a plane, etc.), a building (e.g., a house, an airport, a stadium, a store, etc.), a structure (e.g., a billboard, a banner, a bridge, etc.), or the like. Additionally, or alternatively, the object may include a place, such as a scene of an accident (e.g., a car accident, an explosion, etc.), a scene of a crime (e.g., a burglary, a robbery, etc.), or the like. In some implementations, the object may include a person or a group of persons, such as a driver, a pedestrian, a crowd, or the like.

In some implementations, the object may be stationary (e.g., a building, a billboard, etc.), and control device 220 may determine the object location by determining an address associated with the object. For example, object information device 230 may store the address in a data structure associated with object information device 230, and control device 220 may receive information identifying the address from object information device 230. In some implementations, control device 220 may determine the object location by using geographic information (e.g., an address, a zip code, etc.) to determine a set of latitude and longitude coordinates (e.g., via geocoding).

In some implementations, the object may be associated with a communication device (e.g., a landline telephone, a cellular telephone, a smartphone, etc.), a computing device (e.g., a desktop computer, a laptop computer, a tablet computer, a handheld computer, etc.), or a similar device. Control device 220 may determine the object location associated with the object by use of a GPS, by use of one or more cellular towers (e.g., via trilateration, triangulation, multilateration, etc.), by use of an object tag (e.g., a transponder, an RFID tag, a micro GPS tag, etc.), by use of an Internet Protocol (“IP”) address, or the like.

In some implementations, control device 220 may determine the object location via user input. For example, a user of image capture device 210 and/or object information device 230 may provide user input (e.g., via a keyboard, a user interface, etc.) designating the object location. Additionally, or alternatively, a user of control device 220 may designate the object location. In some implementations, control device 220 may determine the object location based on input provided by emergency personnel. For example, emergency personnel (e.g., fire personnel, medical personnel, police, etc.) may designate a location of an emergency (e.g., a burning building, a car crash, a robbery, etc.). Control device 220 may receive an indication of the location of the emergency (e.g., via a user device associated with the emergency personnel, via object information device 230, etc.).

In some implementations, control device 220 may determine the object location by use of image capture device 210. For example, image capture device 210 may capture an image of the object (e.g., a picture, a video, etc.). Image capture device 210 and/or control device 220 may detect the object by analyzing the image via object recognition software. Control device 220 may receive a notification from image capture device 210 indicating that the object is within viewing distance of image capture device 210 (e.g., that an image of the object is being captured by image capture device 210). Based on the indication, control device 220 may determine the object location.

As further shown in FIG. 4, process 400 may include selecting an image capture device, of the set of image capture devices, based on the location information and the object location (block 430). For example, control device 220 may select an image capture device 210, of the set of image capture devices 210, from which to obtain an image of the object. In some implementations, control device 220 may select image capture device 210 that is nearest to the object based on the location information and the object location. Additionally, or alternatively, control device 220 may select image capture device 210 that is capable of providing the best image of the object (e.g., an image that is unobstructed, an image that is high resolution, etc.).

In some implementations, control device 220 may select image capture device 210 based on a proximity between image capture device 210 and the object. For example, control device 220 may compare the object location with the location information associated with the set of image capture devices 210. Control device 220 may determine a distance associated with each image capture device 210 to the object. Control device 220 may select an image capture device 210, of the set of image capture devices 210, that is geographically nearest to the object location by determining the image capture device 210 that is the shortest distance to the object.

In some implementations, control device 220 may select image capture device 210 by determining that image capture device 210 is within a threshold distance of the object (e.g., a distance close enough so that the object can appear in an image associated with image capture device 210). Additionally, or alternatively, control device 220 may select image capture device 210 based on how well image capture device 210 may view the object. For example, control device 220 may select the image capture device 210, of the set of image capture devices 210, that has a view of the object that is least obstructed by other entities (e.g., trees, buildings, etc.) as compared to views of the object by other image capture devices 210 in the vicinity. Additionally, or alternatively, control device 220 may select image capture device 210 based on determining which image capture device 210, of a set of image capture devices 210 within a threshold distance of the object, is associated with a best image of the object (e.g., a high resolution image, an image associated with an unobstructed view of the object, etc.).

In some implementations, control device 220 may select image capture device 210 based on user input. For example, a user of control device 220 may provide user input (e.g., via a keypad, a keyboard, a user interface, etc.) selecting image capture device 210. Control device 220 may determine image capture device 210 based on the selection. In some implementations, control device 220 may display the set of image capture devices 210 and the object on a map. The user may select image capture device 210 based on the map (e.g., a location of image capture device 210, a direction of travel of image capture device 210, a rate of travel of image capture device 210, etc.). Additionally, or alternatively, control device 220 may select image capture device 210 based on user input received from image capture device 210. For example, a user of image capture device 210 may provide user input (e.g., via a keypad, a keyboard, a user interface, etc.) designating image capture device 210 as the image capture device 210, of the set of image capture devices 210, to provide image information to control device 220.

In some implementations, control device 220 may select image capture device 210 based on images received from multiple image capture devices 210. For example, control device 220 may receive images from multiple image capture devices 210 (e.g., the set of image capture devices 210, a quantity of image capture devices 210 within a threshold distance of the object, etc.). Control device 220 may display the images on a display (e.g., a user interface). A user of control device 220 may select image capture device 210 based on the images (e.g., by selecting an image on the user interface corresponding to image capture device 210). For example, the user may select image capture device 210 corresponding to the image with the clearest view of the object, the image with the highest resolution, the image with the closest view of the object, etc.

In some implementations, control device 220 may select image capture device 210 based on a time period of interest. The time period of interest may include a time in which image capture device 210 was associated with the object (e.g., a time when image capture device 210 captured an image of the object, a time when image capture device 210 was near the object, etc.). For example, control device 220 may determine a history of locations of the set of image capture devices 210 (e.g., a history of movements, routes, driving patterns, etc.). Control device 220 may select an object location and a time period of interest. Control device 220 may determine image capture device 210 by identifying which of the image capture devices 210, of the set of image capture devices 210, was nearest to the object during the time period of interest based on the history of locations of the set of image capture devices 210.

In some implementations, control device 220 may select image capture device 210 based on a history of image information associated with image capture device 210. For example, the history of image information may include a record of images captured by image capture device 210 at particular times and at particular locations (e.g., at particular times and particular locations associated with past movement of image capture device 210). For example, image capture device 210 may store the history of image information (e.g., a record of images captured by image capture device 210 at particular times and at particular locations) in a data structure associated with image capture device 210. Control device 220 may determine a travel history (e.g., a set of locations and times) associated with the movement of image capture device 210. Control device 220 may use the travel history and the history of image information to identify a location and a time of interest (e.g., a location near the object at a particular time).

In some implementations, control device 220 may determine image capture device 210 based on one or more attributes of image capture device 210, such as an image capture device type, a camera type, a storage capacity, a camera resolution, an amount of network bandwidth available to image capture device 210, or the like.

As further shown in FIG. 4, process 400 may include receiving image information associated with the image capture device based on selecting the image capture device (block 440). For example, control device 220 may receive the image information from image capture device 210.

In some implementations, image information may include information captured by image capture device 210. For example, image information may include an image, a photograph, a picture, a video, or the like. In some implementations, control device 220 may receive a live feed of the image information. For example, control device 220 may receive the image information from image capture device 210 as image capture device 210 captures the image information.

In some implementations, control device 220 may receive the image information during a call (e.g., a telephone call, a video call, etc.). For example, control device 220 may call image capture device 210, and may receive the image information via the call. In some implementations, the call may be established via session initiation protocol (“SIP”). For example, control device 220 may use SIP to establish a session (e.g., a unicast session, a multiparty session, etc.) between one or more image capture devices 210 and control device 220. Control device 220 may receive the image information during the session.

As further shown in FIG. 4, process 400 may include providing the image information (block 450). For example, control device 220 may provide the image information for display on a user interface associated with control device 220. In some implementations, control device 220 may provide the image information to image capture device 210 and/or object information device 230. Additionally, or alternatively, control device 220 may stream the image information (e.g., may display the image information as image capture device 210 provides the image information).

In some implementations, control device 220 may display the image information on a map. For example, control device 220 may receive the location information associated with the set of image capture devices 210 and/or the object location associated with the object. Control device 220 may display (via an icon, a symbol, etc.) a location on the map corresponding to the location of image capture device 210 and/or the object. In some implementations, control device 220 may display the image information based on user input. For example, a user of control device 220 may select image capture device 210 (e.g., by selecting an icon on the map corresponding to image capture device 210). Based on the user input, control device 220 may display the image information received from image capture device 210. Additionally, or alternatively, the user may select the object, and control device 220 may display the image information including the object (e.g., a video of the object received from the closest image capture device 210).

In some implementations, control device 220 may display a history of prior locations (e.g., a trail, a path, a route, etc.) associated with image capture device 210 and/or the object during a prior time interval. Control device 220 may receive user input indicating a time period of interest (e.g., a time corresponding to a portion of the history of prior locations) associated with image capture device 210. Based on the user input, control device 220 may display a history of image information corresponding to the time period of interest.

Although FIG. 4 shows example blocks of process 400, in some implementations, process 400 may include additional blocks, different blocks, fewer blocks, and/or differently arranged blocks than those depicted in FIG. 4. Additionally, or alternatively, one or more of the blocks of process 400 may be performed in parallel. Further, one or more blocks may be omitted in some implementations.

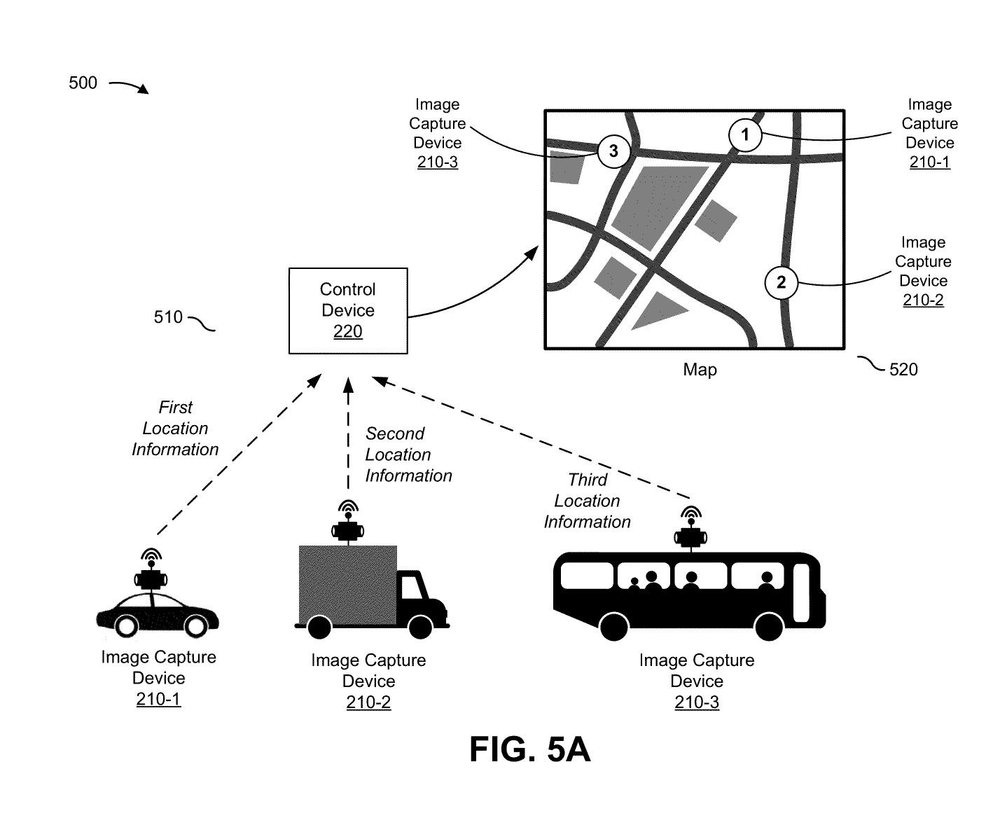

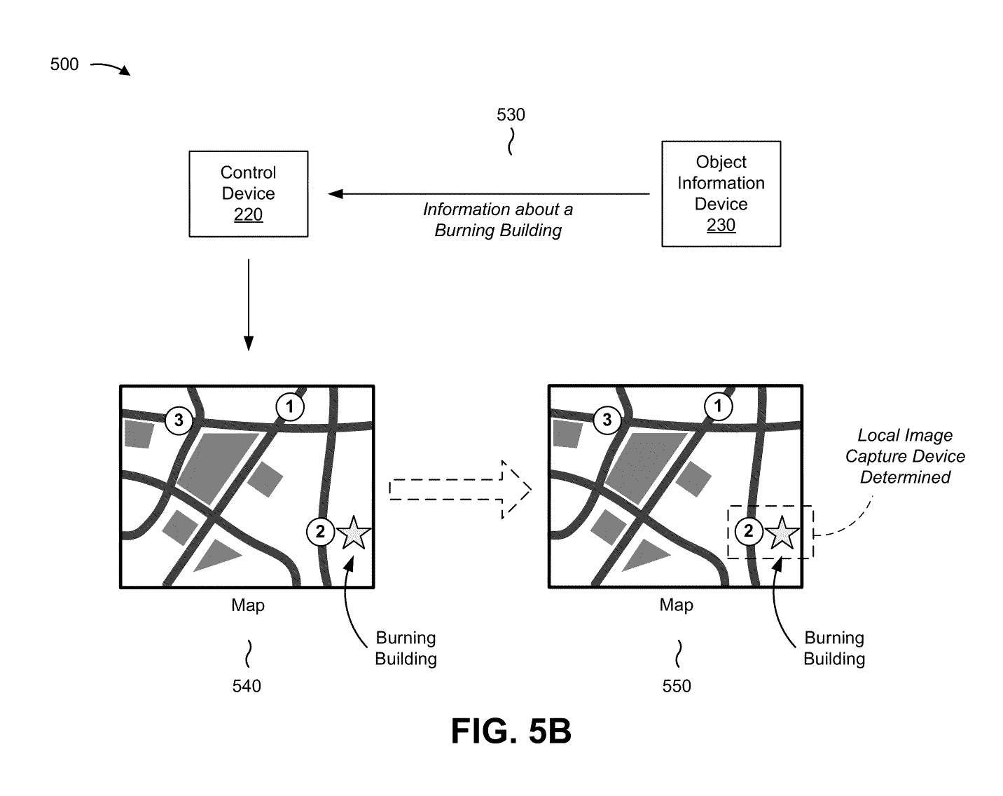

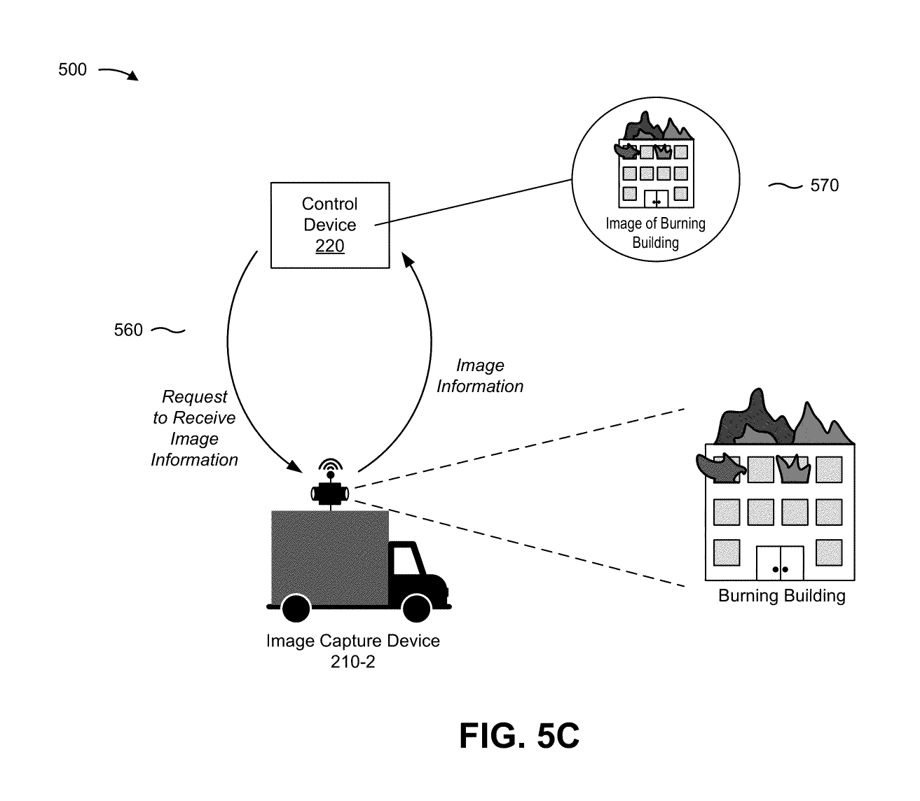

FIGS. 5A-5C are diagrams of an example implementation 500 relating to process 400 shown in FIG. 4. In example implementation 500, a first image capture device 210-1 may be associated with a car, a second image capture device 210-2 may be associated with a truck, and a third image capture device 210-3 may be associated with a bus. Image capture devices 210 may be traveling around a city.

As shown in FIG. 5A, and by reference number 510, control device 220 may receive first location information from first image capture device 210-1, second location information from second image capture device 210-2, and third location information from third image capture device 210-3. The location information (e.g., the first location information, the second location information, and the third location information) may include GPS information that identifies where first image capture device 210-1, second image capture device 210-2, and third image capture device 210-3 are currently located as each image capture device 210 travels around the city. Additionally, or alternatively, the location information may include additional information about each image capture device 210, such as a rate of speed, a direction of travel, or the like.

As shown by reference number 520, control device 220 may display the location information on a map of the city. The map may include information that identifies roads, buildings, addresses, or the like. The map may be displayed on a user interface associated with control device 220. Control device 220 may display a first icon corresponding to the first location information (e.g., a location associated with first image capture device 210-1), a second icon corresponding to second location information (e.g., a location associated with second image capture device 210-2), and a third icon corresponding to the third location information (e.g., a location associated with third image capture device 210-3). A user of control device 220 may view the map and the corresponding location information.

As shown in FIG. 5B, and by reference number 530, control device 220 may receive information about a burning building from object information device 230. The information about the burning building may be obtained from emergency personnel (e.g., fire officers), and may include a location of the burning building (e.g., an address associated with the burning building). As shown by reference number 540, control device 220 may display an icon (e.g., a star) on the map corresponding to the location of the burning building.

As shown by reference number 550, control device 220 may determine that second image capture device 210-2 is closest to the burning building. For example, the user may examine the map and determine whether first image capture device 210-1, second image capture device 210-2, or third image capture device 210-3 is closest to the burning building. The user may select the closest image capture device 210 (e.g., second image capture device 210-2) by providing user input (e.g., the user may select second image capture device 210-2 by touching a region of a touchscreen display corresponding to second image capture device 210-2 and associated with the map). Control device 220 may receive the user input. Additionally, or alternatively, control device 220 may automatically select image capture device 210-2 based on the location of image capture device 210-2 and the location of the burning building.

As shown in FIG. 5C, and by reference number 560, control device 220 may request to receive image information from second image capture device 210-2. For example, control device 220 may send a SIP request to initiate a session (e.g., a call) between image capture device 210-2 and control device 220. Second image capture device 210-2 may capture video of the burning building (e.g., image information). Control device 220 may receive the video of the burning building as the video is captured (e.g., in real-time), as shown by reference number 570.

As indicated above, FIGS. 5A-5C are provided merely as an example. Other examples are possible and may differ from what was described with regard to FIGS. 5A-5C.

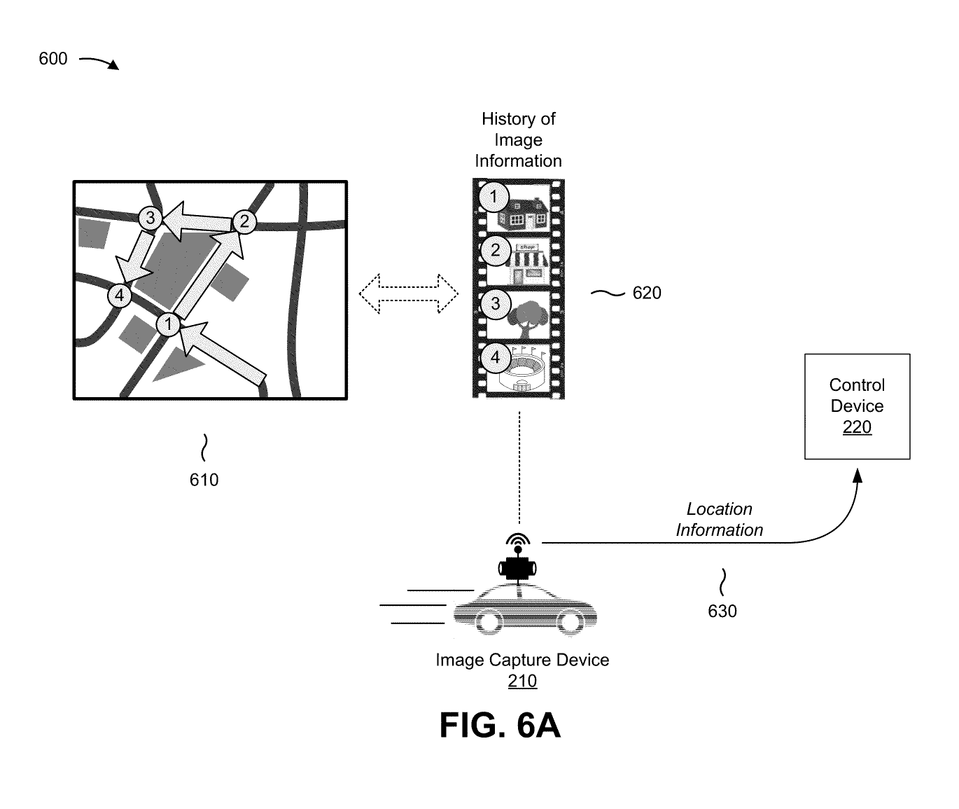

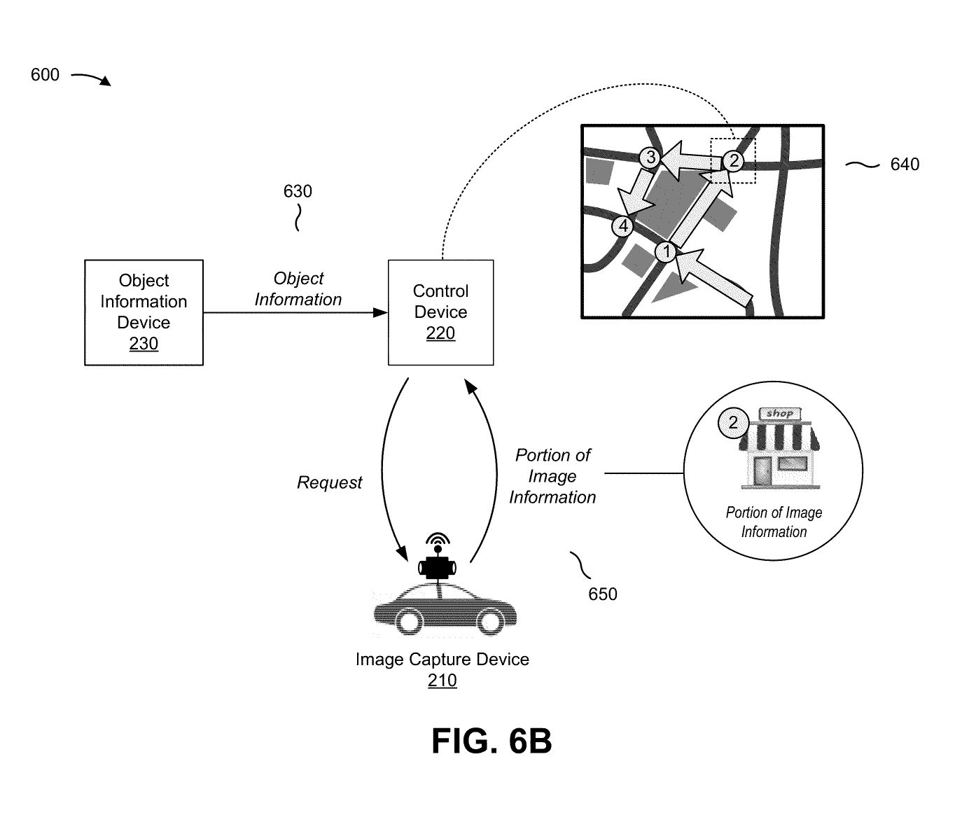

FIGS. 6A-6B are diagrams of an example implementation 600 relating to process 400 shown in FIG. 4. In example implementation 600, image capture device 210 may record a history of image information, and control device 220 may receive a portion of the image information.

As shown in FIG. 6A, and by reference number 610, image capture device 210 may travel through a city and may capture video of surrounding objects (e.g., image information). While traveling through the city, image capture device 210 may spend a period of time outside of a first location (e.g., a house), a second location (e.g., a shop), a third location (e.g., a park) and a fourth location (e.g., a stadium). As shown by reference number 620, image capture device 210 may store a history of image information (e.g., a record of image information obtained as image capture device 210 traveled through the city) in a data structure associated with image capture device 210. Control device 220 may receive location information about the movements of image capture device 210, as shown by reference number 630.

As shown in FIG. 6B, and by reference number 630, control device 220 may receive object information from object information device 230. The object information may identify a robbery at an object location (e.g., the shop) at a particular time. Control device 220 may determine, from a set of location information associated with a set of image capture devices 210, that image capture device 210 was parked near the object location (e.g., outside of the shop) at the time of the robbery, as shown by reference number 640.

As shown by reference number 650, control device 220 may request a portion of the image information based on the object information (e.g., based on the time and the location of the robbery). Image capture device 210 may determine, from the history of image information, the portion of image information that corresponds to the second location (e.g., the shop) at the time of the robbery. Control device 220 may receive the portion of image information from image capture device 210. A user of control device 220 (e.g., police personnel) may view the portion of image information to identify a robbery suspect, gather evidence, or the like.

As indicated above, FIGS. 6A-6B are provided merely as an example. Other examples are possible and may differ from what was described with regard to FIGS. 6A-6B.

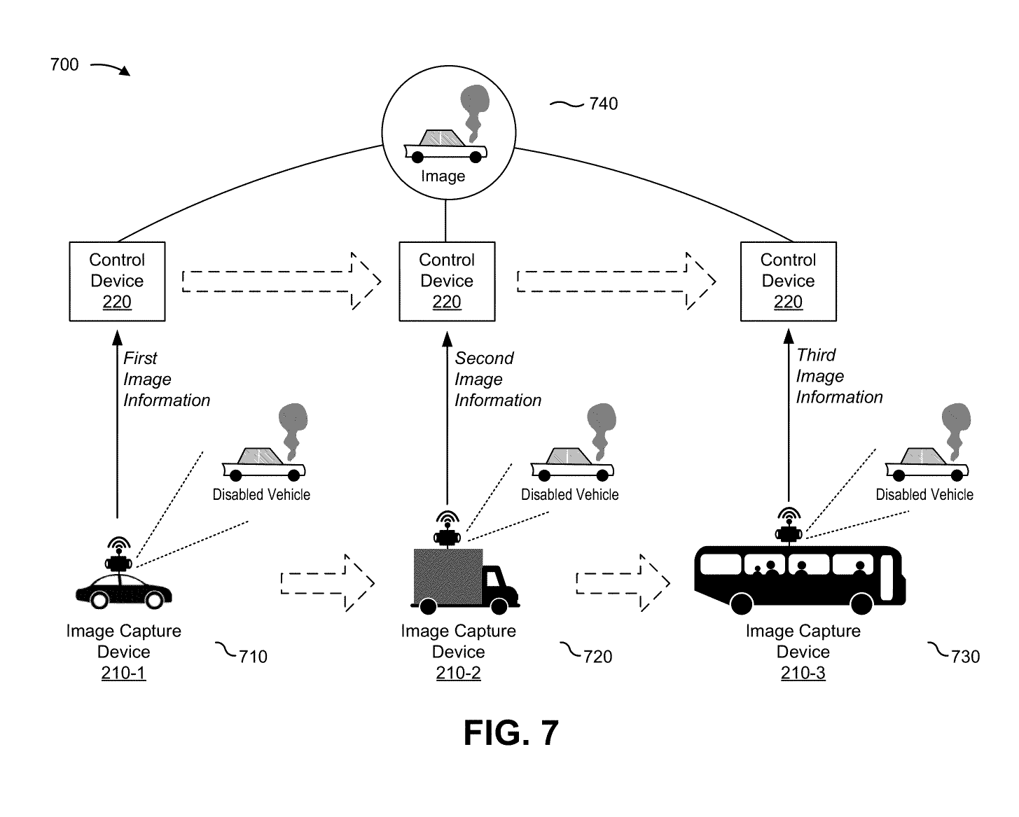

FIG. 7 is a diagram of an example implementation 700 relating to process 400 shown in FIG. 4. In example implementation 700, the object may include a disabled vehicle. Image capture devices 210 may include image capture devices associated with vehicles passing near the disabled vehicle (e.g., driving past the disabled vehicle on a side of the road). As each image capture device 210 passes by the disabled vehicle, control device 220 may receive image information from image capture devices 210.

As shown by FIG. 7, control device 220 may receive location information associated with a set of image capture devices 210, including a first image capture device 210-1 (e.g., associated with a car), a second image capture device 210-2 (e.g., associated with a truck), and a third image capture device 210-3 (e.g., associated with a bus). Control device 220 may receive an object location (e.g., an address, an intersection, etc.) associated with the disabled vehicle, and may determine, from the set of image capture devices 210, the image capture device 210 nearest to the disabled vehicle.

As shown by reference number 710, first image capture device 210-1 may drive by the disabled vehicle. First image capture device 210-1 may capture first video of the disabled vehicle (e.g., first image information). Control device 220 may receive the first video as first image capture device 210-1 drives by the disabled vehicle (e.g., control device 220 may receive a live feed of the disabled vehicle as seen from first image capture device 210-1).

As shown by reference number 720, second image capture device 210-2 may drive by the disable vehicle at a later time. Control device 220 may determine that second image capture device 210-2 is closer to the disabled vehicle than first image capture device 210-1 (e.g., control device 220 may determine that first image capture device 210-1 has driven past the disabled vehicle and is no longer able to capture an image of the disabled vehicle). Second image capture device 210-2 may capture second video (e.g., second image information) of the disabled vehicle, and control device 220 may receive the second video as a live feed.

As shown by reference number 730, third image capture device 210-3 may drive by the disabled vehicle at a later time, and may capture third video (e.g., third image information) of the disabled vehicle. Control device 220 may determine that third image capture device 210-3 is now closer to the disabled vehicle than second image capture device 210-2 (e.g., control device 220 may determine that second image capture device 210-2 has driven past the disabled vehicle and is no longer able to capture an image of the disable vehicle). Control device 220 may receive the video from image capture device 210-3. In this manner, control device 220 may maintain a real-time view of the disabled vehicle by switching among videos provided by image capture devices 210, as shown by reference number 740.

As indicated above, FIG. 7 is provided merely as an example. Other examples are possible and may differ from what was described with regard to FIG. 7.

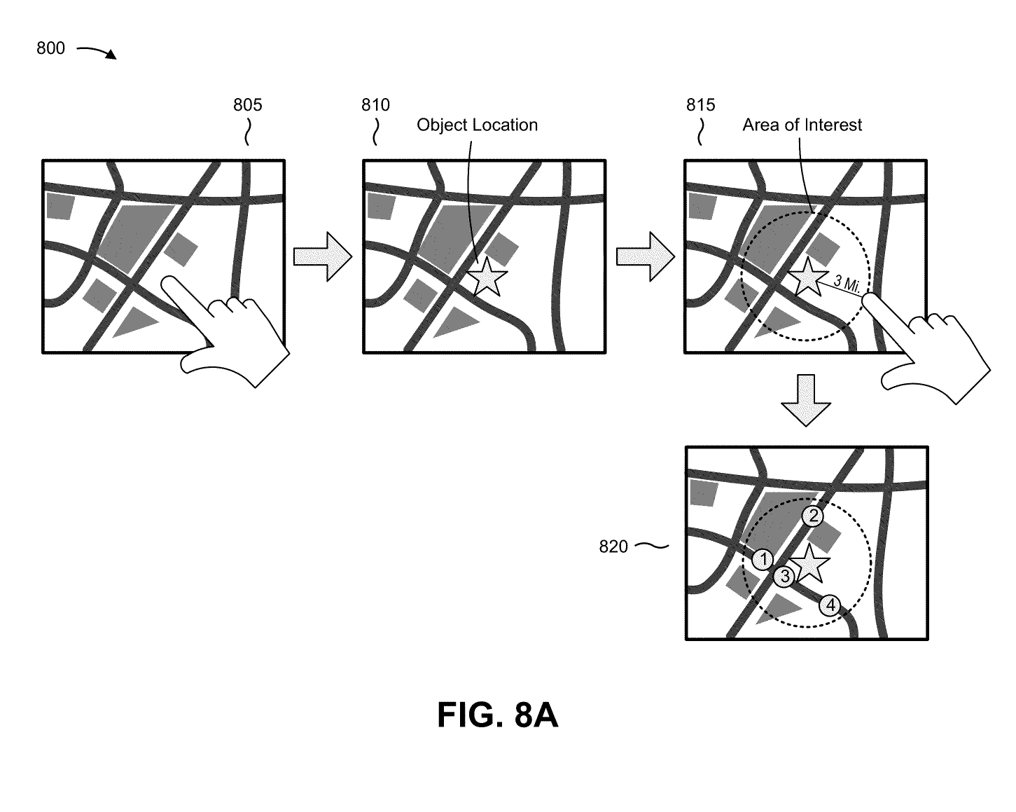

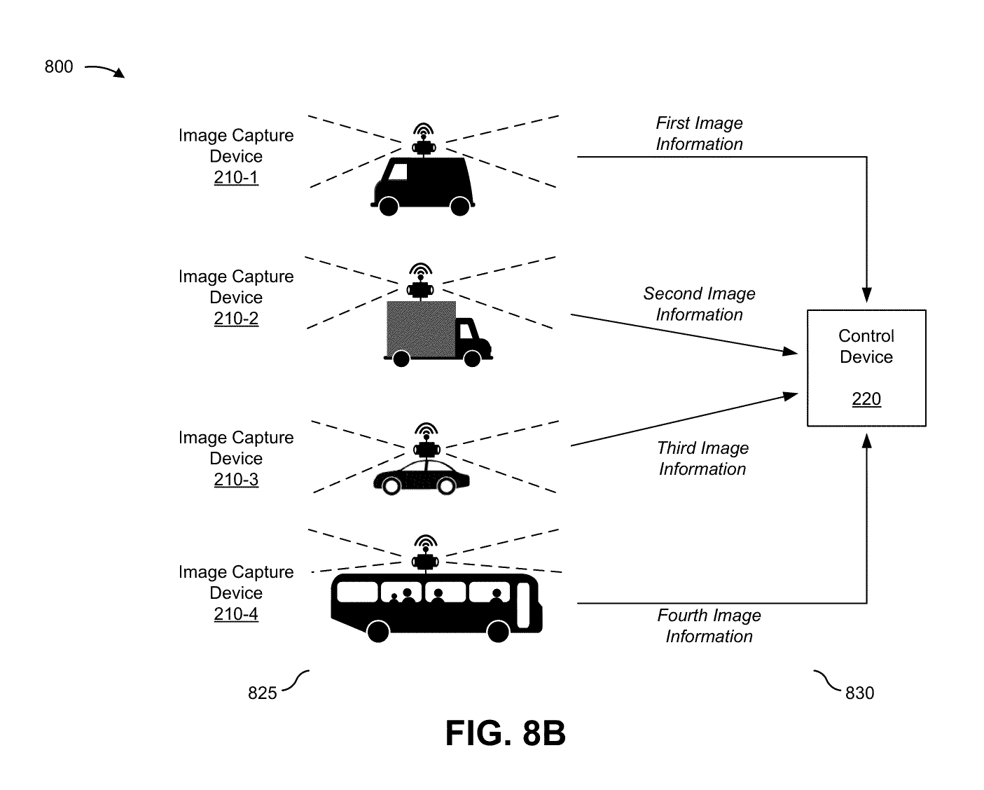

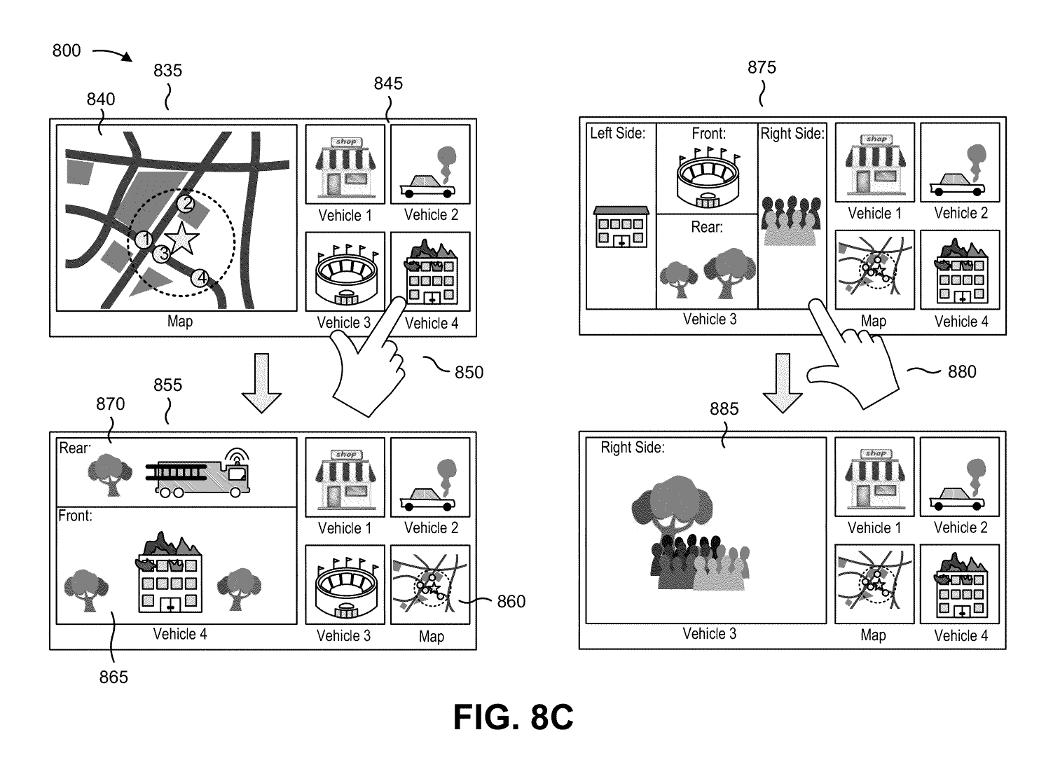

FIGS. 8A-8C are diagrams of an example implementation 800 relating to process 400 shown in FIG. 4. In example implementation 800, a user of control device 220 may select image capture devices 210, and may view image information, via a command center (e.g., a user interface associated with control device 220).

As shown in FIG. 8A, and by reference number 805, control device 220 may display a map of a geographic region. The user may select an object location by selecting a portion of the map (e.g., via a touchscreen display). Based on the user input, control device 220 may determine the object location, and may display the object location on the map, as shown by reference number 810.

As shown by reference number 815, the user may select an area of interest associated with the object location. The area of interest may include a geographic region bound by a circle of a radius (e.g., three miles) from the object location. The user may select the area of interest by selecting the object location (e.g., by touching the object location on the touchscreen) and dragging a finger away from the object for a length representing the radius. Based on the area of interest, control device 220 may determine location information associated with a set of image capture devices, and may display icons representing those image capture devices 210, of the set of image capture devices 210, within the area of interest, as shown by reference number 820.

As shown in FIG. 8B, and by reference number 825, image capture devices 210 (e.g., within the area of interest) may include a first image capture device 210-1, a second image capture device 210-2, a third image capture device 210-3, and a fourth image capture device 210-4. Image capture devices 210 may capture images of areas surrounding image capture devices 210 (e.g., images from a front view, a rear view, and/or a side view of each image capture device 210). As shown by reference number 830, control device 220 may receive image information (e.g., first image information, second image information, third image information, and fourth image information) from image capture devices 210.

As shown in FIG. 8C, and by reference number 835, control device 220 may display the image information as part of a command center. A shown by reference number 840, control device 220 may display the map, along with the area of interest and icons representing locations of the image capture devices 210 within the area of interest. As shown by reference number 845, control device 220 may display first image information associated with first image capture device 210-1 (e.g., “Vehicle 1”), second image information associated with second image capture device 210-2 (e.g., “Vehicle 2”), third image information associated with third image capture device 210-3 (e.g., “Vehicle 3”), and fourth image information associated with fourth image capture device 210-4 (e.g., “Vehicle 4”). As shown by reference number 850, the user may select the fourth image information by touching a region of the touchscreen associated with fourth image capture device 210.

As shown by reference number 855, based on the selection of the fourth image information by the user, control device 220 may display the fourth image information (e.g., as a larger image). The map may be displayed elsewhere, as shown by reference number 860. As shown by reference number 865, the fourth image information may include a front view of a burning building. As shown by reference number 870, a top portion of the fourth image information may include a rear view of a fire truck. The rear view may be captured by use of a mirror associated with fourth image capture device 210-4. The mirror may be located as to capture a substantial portion of side images as seen from sides of fourth image capture device 210-4. In this manner, control device 220 may display a substantially 360° view of a region surrounding fourth image capture device 210-4.

As shown by reference number 870, control device 220 may display third image information (e.g., based on a user selection). The third image information may include images as seen from the front, rear, left side, and right side of third image capture device 210-3 (e.g., third image capture device 210-3 may be capable of capturing images from different angles). As shown by reference number 880, the user may select a view (e.g., a right side view) by touching a region of the touchscreen display associated with the view. As shown by reference number 885, based on the user selection, control device 220 may display the view as a larger portion of the display (e.g., larger than previously displayed). In this manner, a user of control device 220 may select and display multiple views associated with image capture device 210.

As indicated above, FIGS. 8A-8C are provided merely as an example. Other examples are possible and may differ from what was described with regard to FIGS. 8A-8C.

Implementations described herein may allow a control device to determine an image capture device near an object, and to receive an image of the object from the image capture device.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein. In some implementations, the user interfaces may be customizable by a user or a device. Additionally, or alternatively, the user interfaces may be pre-configured to a standard configuration, a specific configuration based on capabilities and/or specifications associated with a device on which the user interfaces are displayed, or a set of configurations based on capabilities and/or specifications associated with a device on which the user interfaces are displayed.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. As used herein, the articles “a” and “an” are intended to include one or more times, and may be used interchangeably with “one or more.” Also, as used herein, the term “set” is intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
determine location information associated with a plurality of image capture devices;
determine an object location associated with an object;
select an image capture device, of the plurality of image capture devices, based on the location information and the object location,
the image capture device being selected based on the location information, of the image capture device, relative to the location information of other ones of the plurality of image capture devices;
receive image information associated with the image capture device based on selecting the image capture device,
the image information including an image of the object; and
provide the image information.

2. The device of claim 1, where the one or more processors, when determining the location information associated with the plurality of image capture devices, are further to:
determine a travel history associated with the plurality of image capture devices,
the travel history including a history of locations of the plurality of image capture devices;
where the one or more processors, when selecting the image capture device, are further to:
determine a time period of interest associated with the object; and
select the image capture device based on the travel history associated with the image capture device and the time period of interest; and
where the one or more processors, when receiving the image information, are further to:
receive a history of image information,
the history of image information including an image of the object during the time period of interest.

3. The device of claim 1, where the image capture device is a first image capture device;
where the image information is first image information;
where the one or more processors are further to:
determine a second image capture device, of the plurality of image capture devices, based on the location information and the object location,
the second image capture device being located closer to the object than the first image capture device; and
receive second image information associated with the second image capture device based on determining the second image capture device,
the second image information including an image of the object.

4. The device of claim 1, where the one or more processors, when determining the location information, are further to:
determine the location information, for the image capture device, based on at least one of:
a global positioning system location associated with the image capture device;
a user input provided by a user of the image capture device; or
a cellular signal associated with the image capture device.

5. The device of claim 1, where the one or more processors, when determining the object location, are further to:
capture an image of the object; and
determine that the image includes the object.

6. The device of claim 1, where the one or more processors, when selecting the image capture device, are further to:
determine that the image capture device is capable of capturing an image of the object.

7. The device of claim 1, where the plurality of image capture devices is a first plurality of image capture devices;
where the one or more processors, when selecting the image capture device, are further to:
determine a second plurality of image capture devices as a subset of the first plurality of image capture devices,
the second plurality of image capture devices being within a threshold proximity of the object; and
where the one or more processors, when receiving the image information associated with the image capture device, are further to:
receive image information from the second plurality of image capture devices.

8. A computer-readable medium storing instructions, the instructions comprising:
one or more instructions that, when executed by one or more processors, cause the one or more processors to:
determine location information associated with a plurality of image capture devices;
determine an object location associated with an object;
select an image capture device, of the plurality of image capture devices, based on the location information and the object location,
the image capture device being selected based on the location information, of the image capture device, relative to the location information of other ones of the plurality of image capture devices;
receive image information associated with the image capture device based on selecting the image capture device,
the image information including an image of the object; and
provide the image information.

9. The computer-readable medium of claim 8, where the one or more instructions, that cause the one or more processors to determine the location information associated with the plurality of image capture devices, further cause the one or more processors to:
determine a travel history associated with the plurality of image capture devices,
the travel history including a history of locations of the plurality of image capture devices;
where the one or more instructions, that cause the one or more processors to select the image capture device, further cause the one or more processors to:
determine a time period of interest associated with the object; and
select the image capture device based on the travel history associated with the image capture device and the time period of interest; and
where the one or more instructions, that cause the one or more processors to receive the image information, further cause the one or more processors to:
receive a history of image information,
the history of image information including an image of the object during the time period of interest.

10. The computer-readable medium of claim 8, where the image capture device is a first image capture device;
where the image information is first image information;
where the one or more instructions, when executed by the one or more processors, further cause the one or more processors to:
select a second image capture device, of the plurality of image capture devices, based on the location information and the object location,
the second image capture device being located closer to the object than the first image capture device; and
receive second image information associated with the second image capture device based on selecting the second image capture device,
the second image information including an image of the object.

11. The computer-readable medium of claim 8, where the one or more instructions, that cause the one or more processors to determine the location information, further cause the one or more processors to:
determine the location information, for the image capture device, based on at least one of:
a global positioning system location associated with the image capture device;
a user input provided by a user of the image capture device; or
a cellular signal associated with the image capture device.

12. The computer-readable medium of claim 8, where the one or more instructions that cause the one or more processors determine the object location, further cause the one or more processors to:
capture an image of the object; and
determine that the image includes the object.

13. The computer-readable medium of claim 8, where the one or more instructions, that cause the one or more processors to select the image capture device, further cause the one or more processors to:
determine that the image capture device is capable of capturing an image of the object.

14. The computer-readable medium of claim 8, where the plurality of image capture devices is a first plurality of image capture devices;
where the one or more instructions, that cause the one or more processors to select the image capture device, further cause the one or more processors to:
select a second plurality of image capture devices of a subset of the first plurality of image capture devices,
the second plurality of image capture devices being within a threshold proximity of the object; and
where the one or more instructions, that cause the one or more processors to receive the image information associated with the image capture device, further cause the one or more processors to:
receive image information from the second plurality of image capture devices.

15. A method, comprising:
determining, by a device, location information associated with a plurality of image capture devices;
determining, by the device, an object location associated with an object;
selecting, by the device, an image capture device, of the plurality of image capture devices, based on the location information and the object location,
the image capture device being capable of capturing an image of the object;
receiving, by the device, image information associated with the image capture device based on selecting the image capture device,
the image information including an image of the object; and
providing, by the device, the image information.

16. The method of claim 15, where determining the location information associated with the plurality of image capture devices further comprises:
determining a travel history associated with the plurality of image capture devices,
the travel history including a history of locations of the plurality of image capture devices;
where selecting the image capture device further comprises:
determining a time period of interest associated with the object;
selecting the image capture device based on the travel history associated with the image capture device and the time period of interest; and
where receiving the image information, further comprises:
receiving a history of image information,
the history of image information including an image of the object during the time period of interest.

17. The method of claim 15, where the image capture device is a first image capture device;
where the image information is first image information;
the method further comprising:
selecting, by the device, a second image capture device, of the plurality of image capture devices, based on the location information and the object location,
the second image capture device being located closer to the object than the first image capture device; and
receiving, by the device, second image information associated with the second image capture device based on determining the second image capture device,
the second image information including an image of the object.

18. The method of claim 15, where determining the location information further comprises:
determining the location information, for the image capture device, based on at least one of:
a global positioning system location associated with the image capture device;
a user input provided by a user of the image capture device; or a cellular signal associated with the image capture device.

19. The method of claim 15, where determining the object location further comprises:
capturing an image of the object; and
determining that the image includes the object.

20. The method of claim 15, where the plurality of image capture devices is a first plurality of image capture devices;
where selecting the image capture device further comprises:
determining a second plurality of image capture devices as a subset of the first plurality of image capture devices,
the second plurality of image capture devices being capable of capturing an image of the object; and
where receiving the image information associated with the image capture device further comprises:
receiving image information from the second plurality of image capture devices.
